(19) United States
(12) Patent Application Publication
(10) Pub. No.: US 2009/0091463 A1
(43) Pub. Date: Apr. 9, 2009

(54) Monitoring protecting system and method of the same

(75) Inventors: Hsin-Heng Su, Changhua County (TW); Ming-Yi Tsai, Taichung (TW); Shiun-Chih Liao, Taichung (TW)

Correspondence Address: BACON & THOMAS, PLLC, 625 SLATERS LANE, FOURTH FLOOR, ALEXANDRIA, VA, 22314-1176, US

(73) Assignee: CHUNGHWA UNITED TELEVISION CO., LTD., Taichung (TW)

(21) Appl. No.: 11/905,776

(22) Filed: Oct. 4, 2007

(51) Int. Cl. G08B 21/00

(52) U.S. Cl. 340/635

(57) ABSTRACT

A monitoring protecting system and a method of the same are provided. The monitoring protecting system includes a playing unit for outputting a warning signal generated when the playing unit is detected to exhibit an abnormal state and receiving a re-starting signal to cause the playing unit to turn off the power and then re-start; a first transmitting channel for transmitting the warning signal; a second transmitting channel for transmitting the re-starting signal; and a monitoring unit for receiving the warning signal via the first transmitting channel and outputting the re-starting signal via the second transmitting channel.

### BACKGROUND OF THE INVENTION

1. Field of the Invention

The present invention relates to a monitoring protecting system and a method of the same, and in particular to a monitoring protecting system which allows a playing unit to turn off the power and re-start to eliminate an abnormal state when the playing unit is monitored to exhibit the abnormal state.

2. Description of Prior Art

The rise and development of Information Appliances (IA) occurs in recent years. Now, there is no clear definition for the information appliances available in the market. With the progress of associated technologies, new-ring products of information appliances have been continuously developed in the market. The products of information appliances primarily integrate computer, communication and consumptive electronic products. Alternatively, depending on the demand of the market or the purpose of the manufacturer, some of the products of information appliances may integrate two of the computer, communication and consumptive electronic products, and some integrate three of them. With the rapid progress of wireless and wideband technologies, the future products of information appliances can exhibit the functions of these two technologies sufficiently, thereby providing more versatile, more convenient and cheaper service of information and communication for the consumers. In other words, the future products of information appliances focus on the convenience, promptness and mobility of accessing the Internet, thereby satisfying the increasing and diversifying demands for the information. Among the products of information appliances, the development of a Set Top Box is most significant. For example, Taiwan Patent No. I221378 discloses a signal-transmitting device characterized by comprising signal-transmitting means, a signal-receiving device and signal-transmitting control means. The signal-transmitting means is capable of transmitting content signals or processing content signals first in a copyright-protected manner and then transmitting the processed signals. The signal-receiving device utilizes the content signals processed and transmitted by the signal-transmitted means but does not have a function of copying the contents. The information of the signal-receiving device is held. The signal-transmitting controlling means is capable of controlling the output of the signals processed and transmitted by the signal-transmitting means according to a determination whether the information of the signal-receiving device connected to the signal-transmitting means is contained in the information held previously.

When an abnormal state is generated during the use of the Set Top Box, such as shutdown due to overheating, since the user does not fully understand the operation of the Set Top Box, the user usually requires the provider of the Set Top Box coming to his/her house to maintain it. According to a statistical data made by the provider, the most common abnormal state can be easily eliminated by merely re-starting the Set Top Box. However, since the user does not understand the operation of the Set Top Box, the provider has to go to the user's house to maintain it, causing the waste of time and money. Therefore, it is an important issue for those engaged in this business to find a way to overcome the above problems.

### SUMMARY OF THE INVENTION

The primary object of the present invention is to allow a playing unit to turn off the power and then re-start to eliminate an abnormal state when the playing unit is monitored to exhibit the abnormal state.

In order to achieve the above objects, the present invention provides a monitoring protecting system and a method of the same. The monitoring protecting system includes a playing unit for outputting a warning signal generated when the playing unit is detected to exhibit an abnormal state and receiving a re-starting signal to cause the playing unit to turn off the power and then re-start; a first transmitting channel for transmitting the warning signal; a second transmitting channel for transmitting the re-starting signal; and a monitoring unit for receiving the warning signal via the first transmitting channel and outputting the re-starting signal via the second transmitting channel.

Further, the present invention provides a monitoring protecting method, which is suitable for a playing unit equipped with a digital Set Top Box and includes the steps of: a detecting step for outputting a warning signal via a first transmitting channel when an abnormal state exists in the playing unit; a monitoring step for outputting a re-starting signal via a second transmitting channel after obtaining the warning signal output by the detecting step; and a re-starting step for allowing the playing unit to turn off the power and re-start after obtaining the re-starting signal output by the monitoring step.

### BRIEF DESCRIPTION OF THE DRAWINGS

FIG. 1 is a schematic view showing the construction of a preferred embodiment of the present invention;

FIG. 2 is a schematic view showing the construction of another preferred embodiment of the present invention; and

FIG. 3 is a flow chat showing another preferred embodiment of the present invention.

### DETAILED DESCRIPTION OF THE INVENTION

The detailed description and technical contents of preferred embodiments of the present invention will be explained with reference to the accompanying drawings.

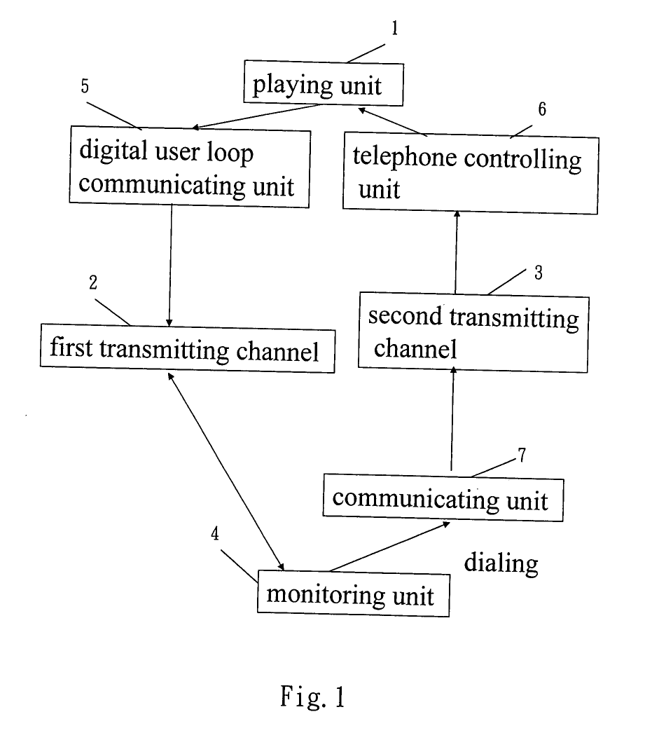

With reference to FIG. 1, it is a schematic view showing the construction of a preferred embodiment of the present invention. As shown in this figure, the present invention provides a monitoring protecting system includes the following components.

A playing unit 1 is provided. The playing unit 1 is capable of outputting a warning signal generated when an abnormal state exists in the playing unit 1, and receiving a re-starting signal for allowing the playing unit 1 to turn off the power and re-start. In the present embodiment, the playing unit 1 is a digital Set Top Box.

A first transmitting channel 2 for transmitting the warning signal and a second transmitting channel 3 for transmitting the re-starting signal are provided. In the present embodiment, the first transmitting channel 2 is an Ethernet, and the second transmitting channel 3 is a telephone line network.

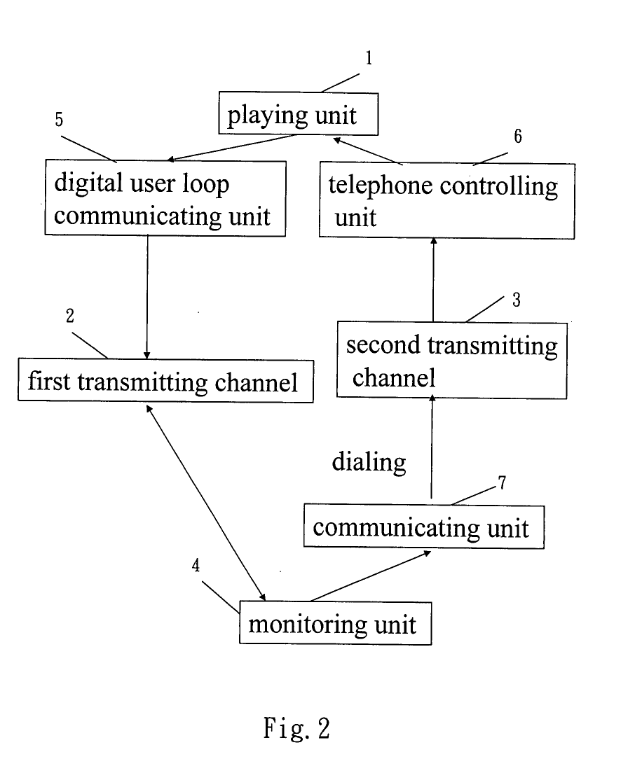

A monitoring unit 4 is provided. The monitoring unit is capable of for receiving the warning signal via the first transmitting channel 2 and outputting the re-starting signal via the second transmitting channel 3. In the present embodiment, a digital user loop communicating unit 5 (such as a router or modem) is provided between the first transmitting channel 2 and the playing unit 1 for acting as a transmitting interface. A telephone controlling unit 6 is provided between the second transmitting channel 3 and the playing unit 1 for turning on/off the power of the playing unit 1. A communicating unit 7 is provided between the monitoring unit 4 and the second transmitting channel 3. FIG. 1 shows that a dialing program (not shown) is stored in the communicating unit 7, so that the communicating unit can be integrated as a dedicated dialing apparatus. FIG. 2 shows that the dialing program is stored in the monitoring unit 4 so as to perform a dialing operation to the communicating unit 7.

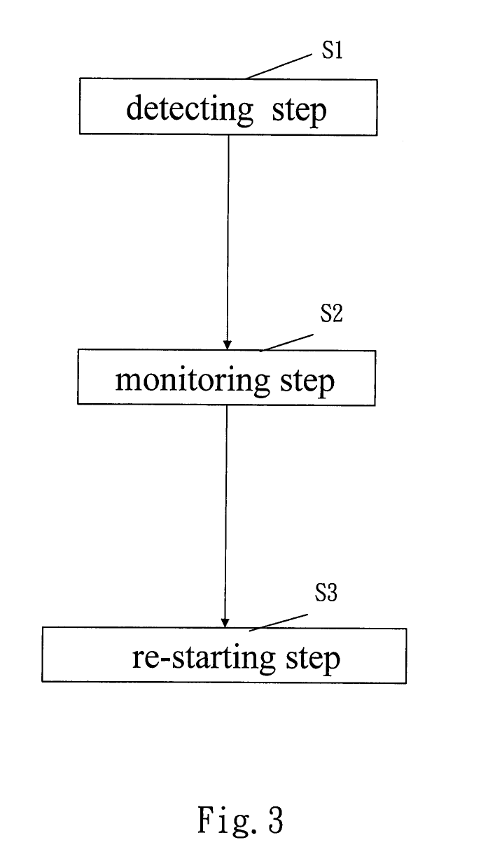

With reference to FIG. 3, it is a flow chat of another embodiment of the present invention. The present invention further provides a monitoring protecting method, which is suitable for a playing unit equipped with a digital Set Top Box and includes the following steps.

A detecting step S1 is provided, in which the playing unit 1 outputs a warning signal via a first transmitting channel 2 when an abnormal signal exists in the playing unit 1.

A monitoring step S2 is provided, in which a re-starting signal is output via a second transmitting channel 3 after obtaining the warning signal output by the detecting step S1. The monitoring step S2 comprises a recording step (not shown). In the recording step, the warning signals and the time points of receiving the signals are recorded to generate a graph, thereby facilitating the inspection.

A re-starting step S3 is provided, in which the playing unit 1 turns off the power and re-starts after obtaining the re-starting signal output by the monitoring step S2.

According to the above, since the monitoring unit 4 outputs a re-starting signal automatically to cause the playing unit 1 to re-start when an abnormal state exists in the playing unit 1, the waste of time and money caused by going to the user's house for maintenance can be avoided. Further, owing to provision of both the first transmitting channel 2 and the second transmitting channel 3, if the first transmitting channel 2 (such as Ethernet) is busier, the second transmitting channel 3 that is not used so frequently can be utilized to transmit the re-starting signal, thereby assuring the promptness in transmitting the re-starting signal and further exhibiting the transmitting performance of the second transmitting channel 3. Therefore, the present invention indeed has novelty and inventive steps and conforms to the requirements for an invention patent.

Although the present invention has been described with reference to the foregoing preferred embodiments, it will be understood that the invention is not limited to the details thereof. Various equivalent variations and modifications with regard to the construction or arrangement thereof can still occur to those skilled in this art in view of the teachings of the present invention. Thus, all such variations and equivalent modifications are also embraced within the scope of the invention as defined in the appended claims.

What is claimed is:

1. A monitoring protecting system, comprising:
a playing unit for outputting a warning signal generated when the playing unit is detected to exhibit an abnormal state and receiving a re-starting signal to cause the playing unit to turn off the power and then re-start;
a first transmitting channel for transmitting the warning signal;
a second transmitting channel for transmitting the re-starting signal; and
a monitoring unit for receiving the warning signal via the first transmitting channel and outputting the re-starting signal via the second transmitting channel.

2. The monitoring protecting system according to claim 1, wherein the playing unit is a digital Set Top Box.

3. The monitoring protecting system according to claim 1, wherein the first transmitting channel is an Ethernet.

4. The monitoring protecting system according to claim 1, wherein a digital user loop communicating unit is provided between the first transmitting channel and the playing unit.

5. The monitoring protecting system according to claim 4, wherein the digital user loop communicating unit is a router.

6. The monitoring protecting system according to claim 4, wherein the digital user loop communicating unit is a modem.

7. The monitoring protecting system according to claim 1, wherein the second transmitting channel is a telephone line network.

8. The monitoring protecting system according to claim 7, wherein a telephone controlling unit is provided between the second transmitting channel and the playing unit for turning on/off the power of the playing unit.

9. The monitoring protecting system according to claim 1, wherein a communicating unit is provided between the monitoring unit and the second transmitting channel.

10. The monitoring protecting system according to claim 1, wherein the communicating unit cooperates with a dialing program stored in the monitoring unit.

11. The monitoring protecting system according to claim 1, wherein the communicating unit is provided with a dialing program therein.

12. A monitoring protecting method, suitable for a playing unit equipped with a digital Set Top Box and including the steps of:
a detecting step for outputting a warning signal via a first transmitting channel when an abnormal state exists in the playing unit;
a monitoring step for outputting a re-starting signal via a second transmitting channel after obtaining the warning signal output by the detecting step; and
a re-starting step for allowing the playing unit to turn off the power and re-start after obtaining the re-starting signal output by the monitoring step.

13. The monitoring protecting method according to claim 12, wherein the monitoring step comprises a recording step for recording the warning signals and the time points of receiving the signals.
